(19) United States
(12) Patent Application Publication
(10) Pub. No.: US 2006/0064948 A1
(43) Pub. Date: Mar. 30, 2006

(54) Surcingle sets and methods of making

(75) Inventor: Chia-Wei Chang, Menlo Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Eastwest International (Taiwan) Enterprises, Taichung (TW)

(21) Appl. No.: 10/949,726

(22) Filed: Sep. 24, 2004

(51) Int. Cl. B68C 1/00

(52) U.S. Cl. 54/23

(57) ABSTRACT

Improved surcingle sets useful with equestrian equipment, and methods of making the surcingle sets, are provided. One such surcingle set (200) for use with equestrian equipment includes a male component (250) and a female component (210). The male component has an extension (260) extending from a surface (268) thereof. The female component has a coupling hole (220) disposed therethrough, the coupling hole including a first hole (222) and a smaller second hole (224) connected to the first hole. An inner surface of the coupling hole has a friction layer (214) disposed thereover. The friction layer has a greater coefficient of friction than the extension. By increasing the friction between the extension and the coupling hole, the extension has a more secure fit in the hole and the likelihood for unintended slippage between the extension and coupling hole is reduced.

### BACKGROUND OF THE INVENTION

The present invention relates generally to surcingle sets, and more specifically, to improved surcingle sets which will be particularly useful with equestrian equipment and methods of making the surcingle sets.

The use of horses for both work and play typically requires a variety of accessories and equipment. For example, most people ride horses using a saddle. Underneath the saddle may exist a blanket or liner of sorts to protect the horse from saddle movements. Various saddle bags and other blankets also may be used. For most of this equipment it is desirable to have an attachment mechanism to firmly couple the equipment to the horse or to another piece of equipment on the horse. A variety of clips and belts are typically used. In some cases, surcingle sets are used.

As shown in FIGS. 1A-1B, a prior art surcingle set 100 includes a male member 110 and a female member 120. Male member 110 has a T-shaped extension 112 which is received by a slotted extension 122 in female member 120. Slotted extension 122 has a lip 124 which holds T-shaped extension 112 in place when male and female members 110, 120 are coupled. As can be visualized with reference to FIGS. 1A and 1B, T-shaped extension 112 must be rotated ninety degrees (90°) relative to slotted extension 122 prior to insertion into slotted extension 122. Once T-shaped extension 112 has been received in slotted extension 122, male component 110 is again rotated ninety degrees (90°) relative to female component 120 to lock the two members 110, 120 together as shown in FIG. 1B. Although these type of surcingle sets 100 provide some benefits, one disadvantage is the requirement that one or both members 110, 120 be rotated to couple the two members. Further, movements of the horse, including running, jumping and the like, may cause the coupled surcingle set to decouple. Improvements are desired.

### BRIEF SUMMARY OF THE INVENTION

The present invention relates generally to surcingle sets, and more specifically, to improved surcingle sets for use with equestrian equipment and methods of making the surcingle sets. Surcingle sets of the present invention will be useful for a wide range of equestrian equipment, and provide for a more secure attachment. Surcingle sets of the present invention also will be useful in non-equestrian fields. For example, bags, backpacks, camping gear, sporting equipment, and a wide range of other items which require an attachment device will be able to make use of surcingle sets of the present invention.

In one embodiment of the present invention, a surcingle set for use with equestrian equipment includes a male component and a female component. The male component has an extension extending from a surface thereof. The female component has a coupling hole disposed therethrough, the coupling hole including a first hole and a smaller second hole connected to the first hole. An inner surface of the coupling hole has a friction layer disposed thereover. The friction layer has a greater coefficient of friction than the extension. By increasing the friction between the extension and the coupling hole, the extension has a more secure fit in the hole. Further, the likelihood for unintended slippage between the extension and coupling hole is reduced. In some aspects, the extension or the male component has a second friction layer disposed thereover, to further increase the friction between the extension and the coupling hole.

In some aspects, the female component includes an inner layer and an outer layer, with the outer layer comprising the friction layer. The inner layer includes a metal in some aspects. The metal inner layer helps provide structural strength to the surcingle set. In alternative aspects, the friction layer includes a plastic, a rubber, or the like. The extension is a mushroom-shaped extension in one embodiment. In another embodiment, the extension has a bulbous tip or enlarged end disposed at an end of a stem. The stem has a smaller width or diameter than a tip width or diameter. In some aspects, a width of the extension tip is smaller than the first hole width and larger than the second hole width. In this manner, the enlarged extension end is adapted to be received through the first hole, but is not adapted to be received through the smaller second hole. The stem portion is adapted to slide between the first hole and the second smaller hole. This may occur, for example, upon the application of a force to the extension that is greater than the increased level of friction.

In some aspects, the male and/or female component(s) further include an opening passing therethrough for coupling the male and/or female component(s) to an equestrian equipment piece. The equestrian equipment may be a blanket, leg guard, bag, or the like.

The present invention further provides methods of making a surcingle set for use with equestrian equipment. One such method includes providing a male component having an extension, and providing a female component inner layer. The inner layer has a coupling hole disposed therethrough, with the coupling hole having a first hole and a smaller second hole connected to the first hole. The method further includes coating the female component inner layer with an outer layer that has a higher coefficient of friction than the inner layer. The male and/or female components may be attached to one or more equestrian pieces of equipment.

Other objects, features, and advantages of the present invention will become more fully apparent from the following description, the appended claims, and the accompanying drawings.

### BRIEF DESCRIPTION OF THE DRAWINGS

FIGS. 1A-1B are overall views of prior art surcingles;

FIGS. 2A and 2B are overall views of female and male components, respectively, of a surcingle set according to an embodiment of the present invention;

FIG. 3A is a partial cutaway view of a female surcingle set component according to an embodiment of the present invention;

FIG. 3B is an overall view of a female surcingle set component inner layer according to an embodiment of the present invention;

FIGS. 3C-3E are schematic top, rear and side views of the female component depicted in FIG. 2A;

FIGS. 4A-4C are schematic top, front and side views of the male component depicted in FIG. 2B;

FIG. 5A is an overall view of a coupled surcingle set according to an embodiment of the present invention; and

FIGS. 5B-5D are schematic top, side and front views of the coupled surcingle set shown in FIG. 5A.

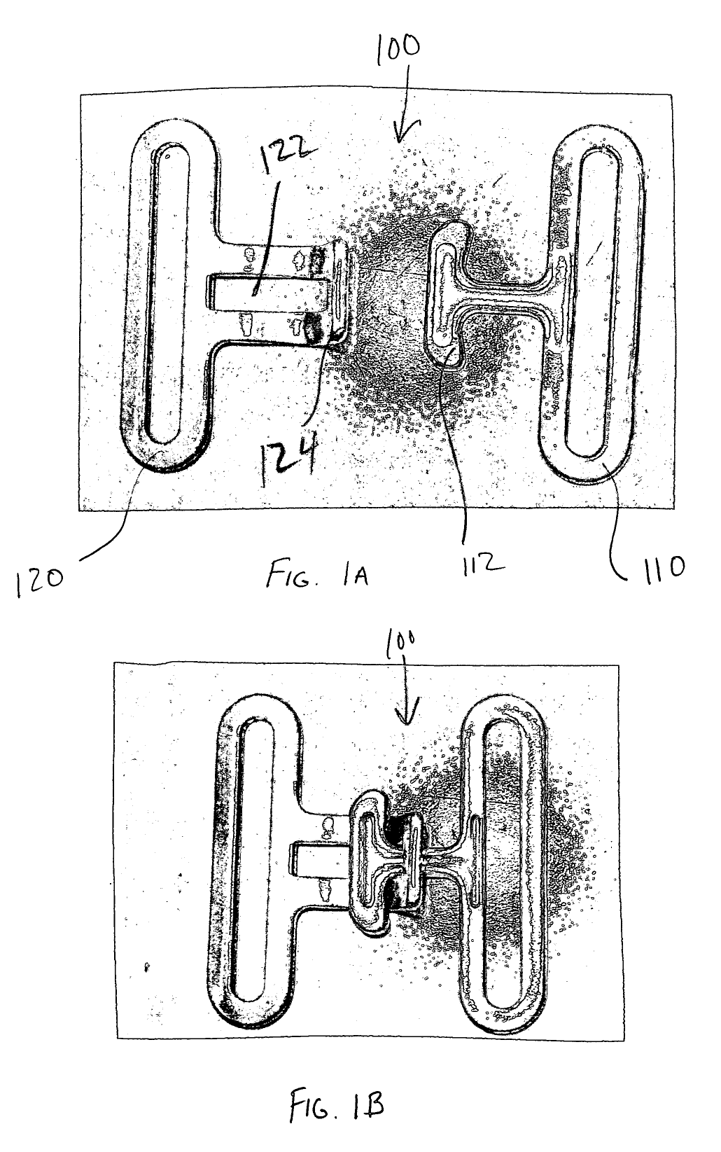

### DETAILED DESCRIPTION OF THE INVENTION

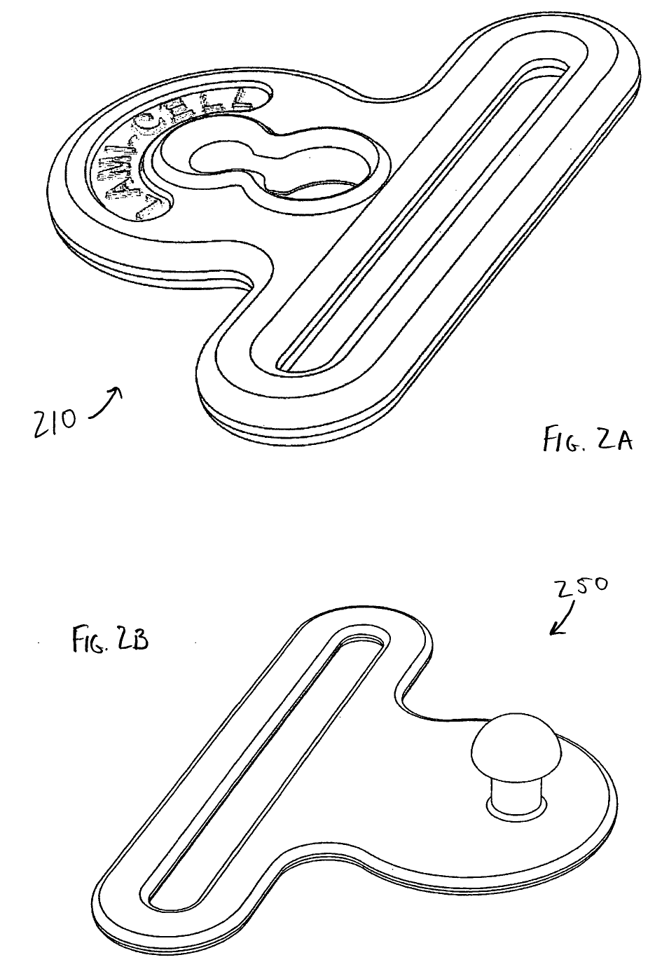

With reference to FIGS. 2A-5D, an embodiment of a surcingle set 200 according to the present invention will be described. It will be appreciated by those skilled in the art that modifications may be made to the various components within the scope of the present invention. Further, the following description is intended to be illustrative of the invention and not limiting. Surcingle sets of the present invention will have a wide variety of uses in a number of different fields which require a secure attachment device. For example, surcingle sets of the present invention will be useful in the equestrian field, and may be used for coupling blankets, bags, leg guards, saddles, and other equipment to horses or other draft animals. Surcingle sets of the present invention will be particularly useful on the horse blankets described in U.S. application Ser. No. ______, entitled “Horse Blankets And Methods of Making,” filed contemporaneously herewith, assigned to the assignee of the present invention, the complete disclosure of which is incorporated herein by reference. In some embodiments, the surcingle sets will be useful for coupling the equipment directly to the animal, while in other embodiments the surcingle sets will be useful for coupling equipment to another piece of equipment.

In one embodiment, surcingle set 200 includes a female component 210 (FIG. 2A) and a male component 250 (FIG. 2B). Female component 210 includes a base portion 216 and an attachment portion 218. Base portion 216 has an opening 230 disposed therethrough. Opening 230 is adapted to receive straps, bands, or other attachment devices which pass through opening 230 for coupling female component 210 to equestrian equipment. While depicted as an elongate slot, opening 230 may have other shapes within the scope of the present invention. Base portion 216 also may be shaped differently in alternative embodiments.

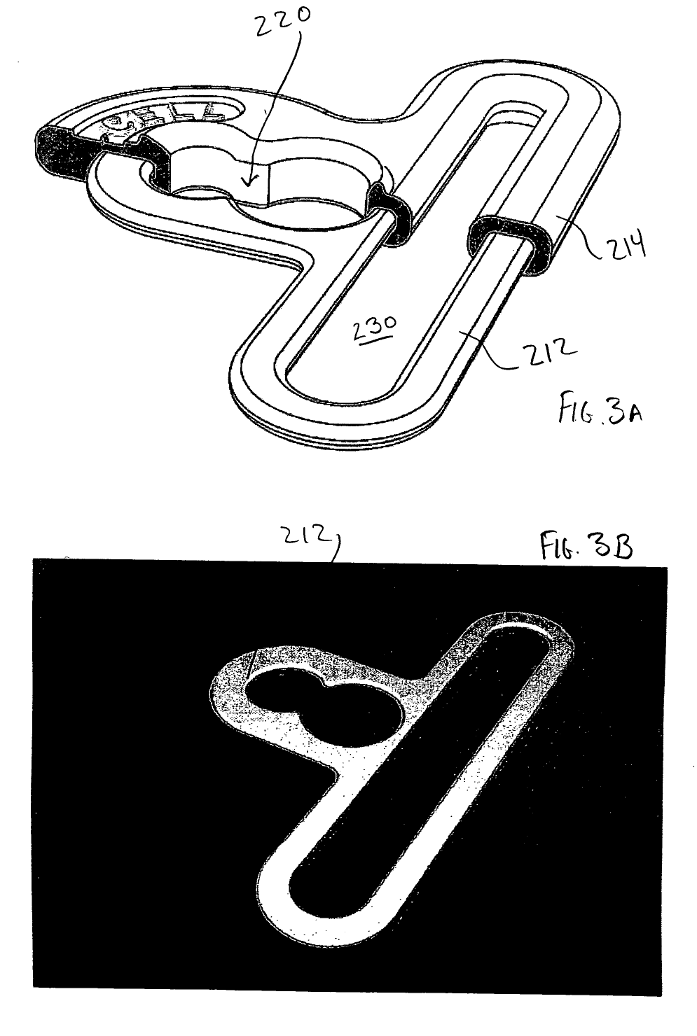

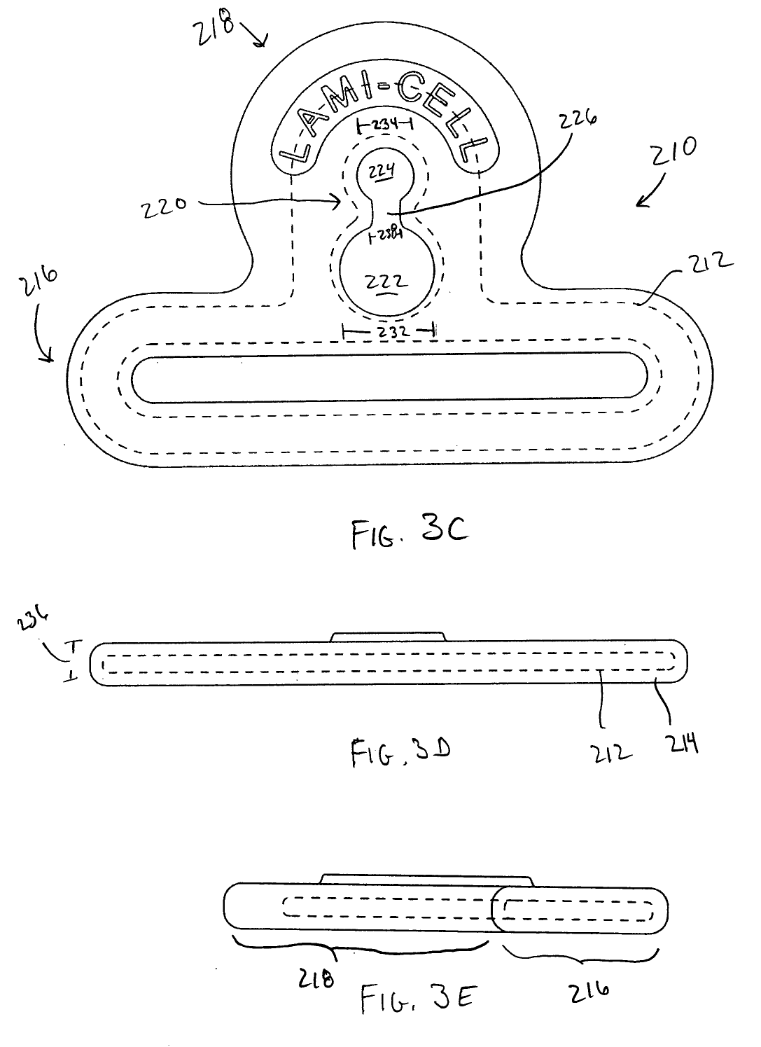

As shown in FIGS. 3A-3E, attachment portion 218 includes a coupling hole 220 disposed therethrough. In one embodiment, coupling hole 220 includes a first hole 222 and a second hole 224. First hole 222 has a greater width or diameter 232 than a width or diameter 234 of second hole 224. In a particular embodiment, first and second holes 222, 224 are connected together by a channel 226. In other embodiments, first and second holes 222, 224 are coupled together without a channel.

In one embodiment, female component 210 includes an inner layer 212 and an outer layer 214. As can be seen in FIG. 3B, in one embodiment inner layer 212 is a hard or rigid layer over which outer layer 214 is disposed. In a particular embodiment, inner layer 212 is a metal, a ceramic, or the like. In some embodiments, outer layer 214 is a plastic, a rubber, polyethylene, a ceramic, or the like. Female component 210 may be manufactured by first forming inner layer 212 using standard molding, casting or the like techniques. Outer layer 214 is then formed over the desired portion of inner layer 212. Outer layer 214 may be sprayed, wiped, molded, cast or otherwise applied to inner layer 212. In other embodiments, inner layer 210 is submerged in a container holding outer layer 214 in liquid form, removed from the container and dried. Other manufacturing techniques also are possible within the scope of the present invention.

As can be seen with reference to the dotted lines in FIGS. 3C-3E, in one embodiment outer layer 214 completely encompasses inner layer 212. In another embodiment, outer layer 214 is disposed over the exposed surfaces of opening 220. In this embodiment, only the surfaces of opening 220, which are adapted to engage male component 250, have outer layer 214. In a particular embodiment, outer layer 214 has a greater coefficient of friction than does inner layer 212. In this manner, outer layer 214 provides greater resistance to the male component as further described below. Female component 210 has a thickness 236 as shown in FIG. 3D. Thickness 236 may be a uniform thickness, or thickness 236 may vary at different positions of female component 210.

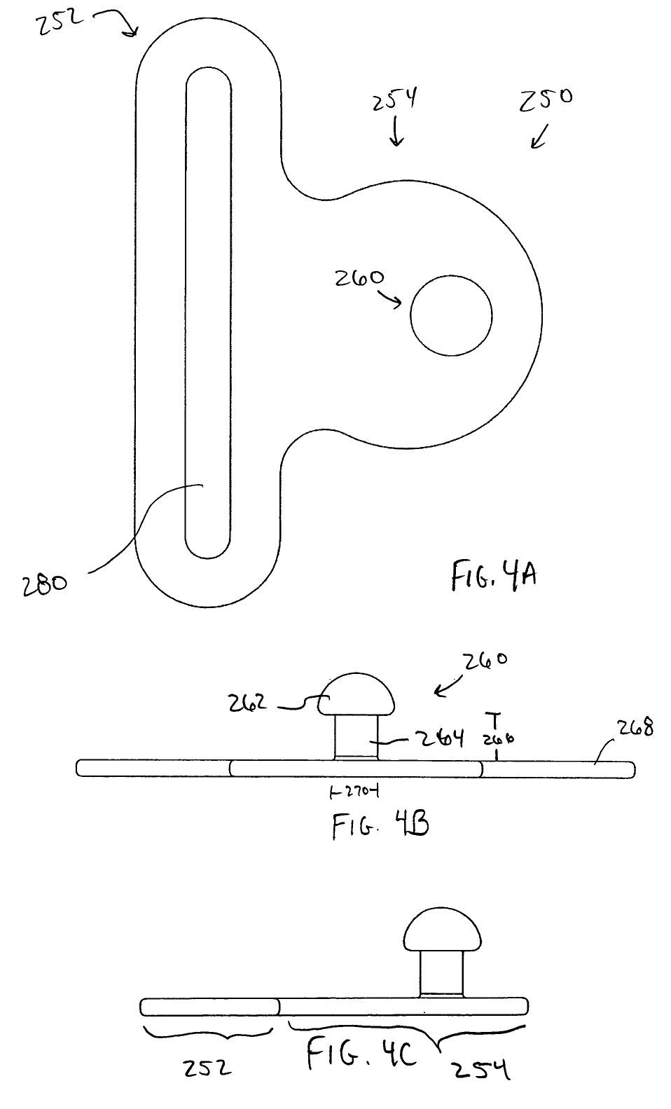

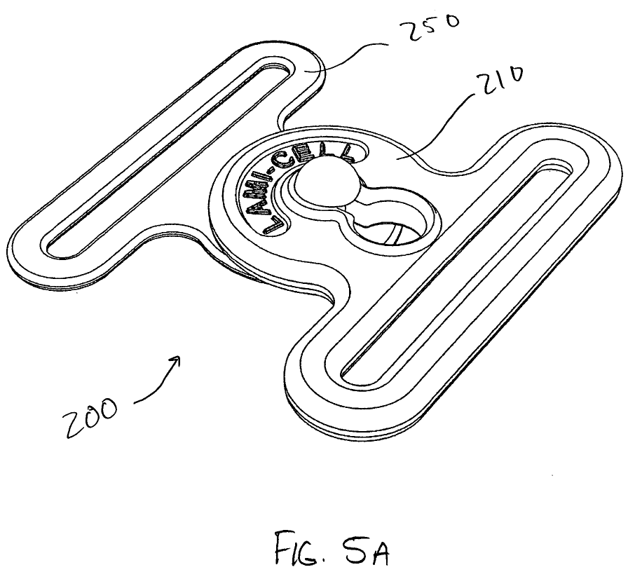

An embodiment of male component 250 is further depicted in FIGS. 4A-4C. Male component 250 includes a base portion 252 and an attachment portion 254. Base portion 252 has a slot or opening 280 passing therethrough, similar to opening 230. Slot 280 is adapted to permit the coupling of male component 250 to straps, bands, buckles, or the like associated with equestrian equipment. Again, base portion 252 and/or slot 280 may have different shapes in alternative embodiments of the present invention. Attachment portion 254 includes an extension 260 which extends from a surface 268 of male component 250. In one embodiment, extension 260 is a generally mushroom-shaped extension 260. In another embodiment, extension 260 has a bulbous tip 262 disposed at an end of a stem 264. As can be seen in FIGS. 4B and 4C, tip 262 has a greater width or diameter than does stem 264. Tip 262 is disposed at a height 266 from surface 268. Height 266 in some embodiments corresponds to a length of stem 264.

In a particular embodiment, at least a portion of male component 250 further includes an outer layer. The outer layer (not shown) of male component 250 may cover the entire male component 250, or may cover only a portion of male component 250. In one embodiment, the outer layer covers only extension 260. In another embodiment, the outer layer covers stem 264. Male component 250 outer layer may comprise a variety of materials, including rubber or the like, and may be manufactured in a similar or same fashion as the outer layer for female component 210. In a particular embodiment, the outer layer over male component 250 has a higher coefficient of friction than does the underlying layer of male component 250. Further, in one embodiment some or all of male component 250 has an outer layer while female component 210 does not. In this manner, male component 250 provides the increased friction layer to produce a more secure coupling of male and female components 250, 210.

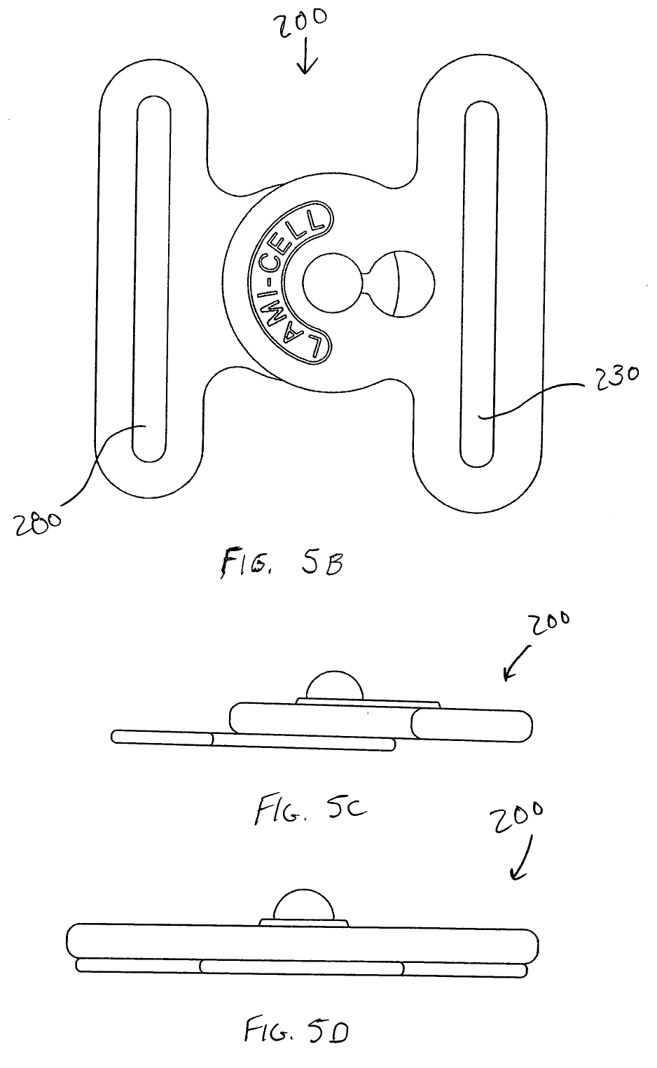

Turning now to FIGS. 5A-5D, the operation of surcingle set 200 will be described. As can be seen, the use of surcingle set 200 involves the coupling of female component 210 with male component 250. This coupling occurs by female component 210 receiving extension 260 within the larger, first hole 222. Extension 260, and more specifically tip 262, has a width or diameter that is less than or equal to width or diameter 232 of first hole 222. Further, height 266 is greater than or equal to thickness 236 of female component 210. As a result, female component 210 and/or male component 250 may be slid relative to each other so that stem 264 slides from first hole 222 into second hole 224. In one embodiment, stem 264 passes from first hole 222 through channel 226 into second hole 224. In another embodiment, stem 264 passes from first hole 222 directly into second hole 224. In a particular embodiment, the sliding of stem 264 from first hole 222 into second hole 224 requires the application of a sliding force to extension 260 and/or to male component 250 that is greater than the friction between stem 264 and the exposed portion of coupling hole 220.

Further, the width or diameter of tip 262 is preferably greater than width or diameter 234 of second hole 224 such that male component 250 and female component 210 remain coupled. More specifically, tip 262 cannot slip directly through second hole 224, but can only be passed through first hole 222. In this manner, male and female portions 250, 210 are decoupled by sliding stem 264 back into first hole 222 and removing tip 262 through first hole 222.

In one embodiment, a width 270 of stem 264 is about equal to a width 238 of channel 226. Further, in the embodiment in which first and second holes 222, 224 are connected without channel 226, width 238 corresponds to the opening in the adjoined portion of holes 222, 224. In this manner, stem 264 may be slid between first hole 222 and second hole 224 with the application of force to male component 250 and/or female component 210 in the desired direction. In a particular embodiment, width 270 of stem 264 is slightly greater than width 238 of channel 226 or the opening between first and second holes 222, 224. In this embodiment, stem 264 and/or the outer layer portion 214 disposed within coupling hole 220 compresses to permit stem 264 to pass through the narrower channel or opening 226. Upon receipt into smaller hole 224, an even greater force must be applied to extension 260 to cause stem 264 to pass through the narrowed channel or opening 226 in coupling hole 220. In a preferred embodiment, the material comprising outer layer 214 of female component 210 provides increased friction between stem 264 and the exposed surfaces of coupling hole 220. In this manner, coupled components 210, 250 remain in the desired orientation.

A more secure surcingle set coupling results by requiring a greater sliding force to be applied to one or both components 210, 250 to change the coupling orientation of extension 260 within coupling hole 220. This is particularly important on horses or other larger animals as their movement may produce two hundred kilograms (200 kg) or three hundred kilograms (300 kilograms) or greater force on surcingle set 200. This force is typically greater than the maximum force plastic locking clips can resist. Further, surcingle set 200 maintains its structural integrity in the event the horse jumps or moves suddenly to create the large pulling force.

The invention has now been described in detail. However, it will be appreciated that the invention may be carried out in ways other than those illustrated in the aforesaid discussion, and that certain changes and modifications may be practiced within the scope of the appended claims. Accordingly, the scope of this invention is not intended to be limited by those specific example, but rather to be accorded the scope represented in the following claims.

What is claimed is:

1. A surcingle set for use with equestrian equipment, the surcingle set comprising:
a male component having an extension extending from a surface of the male component;
a female component having a coupling hole disposed therethrough, the coupling hole comprising a first hole and a smaller second hole, the first and second holes connected by a channel;
wherein an inner surface of the coupling hole has a friction layer disposed thereover, the friction layer having a greater coefficient of friction than the extension.

2. The surcingle set as in claim 1 wherein the female component comprises an inner layer and an outer layer, the outer layer comprising the friction layer.

3. The surcingle set as in claim 2 wherein the inner layer comprises a metal.

4. The surcingle set as in claim 1 wherein the friction layer comprises a plastic.

5. The surcingle set as in claim 1 wherein the friction layer comprises a rubber.

6. The surcingle set as in claim 1 wherein the extension is a mushroom-shaped extension.

7. The surcingle set as in claim 1 wherein the extension comprises a bulbous tip disposed at an end of a stem, the stem having a smaller width or diameter than a tip width or diameter.

8. The surcingle set as in claim 1 wherein the male component further comprises a opening passing therethrough for coupling the male component to an equestrian equipment piece.

9. The surcingle set as in claim 1 wherein the female component further comprises a opening passing therethrough for coupling the female component to an equestrian equipment piece.

10. The surcingle set as in claim 1 wherein the male component further comprises a second friction layer disposed thereover.

11. The surcingle set as in claim 1 wherein a width of a tip of the extension is smaller than a first hole width and is larger than a second hole width.

12. A surcingle set comprising:
a male component having an extension;
a female component having a coupling hole disposed therethrough, the coupling hole comprising a first hole and a smaller second hole connected to the first hole;
wherein the female component comprises an inner layer and an outer layer, the outer layer providing an increased level of friction with the extension than would the inner layer.

13. The surcingle set as in claim 12 wherein the inner layer comprises a metal and the outer layer is a plastic layer.

14. The surcingle set as in claim 12 wherein the inner layer comprises a metal and the outer layer is a rubber layer.

15. The surcingle set as in claim 12 wherein the extension has a stem portion and an enlarged end, wherein the enlarged end is adapted to be received through the first hole and is not adapted to be received through the smaller second hole, and wherein the stem portion is adapted to slide between the first hole and the second smaller hole.

16. The surcingle set as in claim 15 wherein the stem portion is adapted to slide between the first hole and the second smaller hole upon the application of a force to the extension that is greater than the increased level of friction.

17. The surcingle set as in claim 12 wherein the extension further comprises an outer friction layer for providing increased friction between the extension and the coupling hole.

18. A method of making a surcingle set for use with equestrian equipment, the method comprising:
providing a male component having an extension;
providing a female component inner layer, the inner layer having a coupling hole disposed therethrough, the coupling hole comprising a first hole and a smaller second hole connected to the first hole;
coating the female component inner layer with an outer layer, the outer layer having a higher coefficient of friction than the inner layer.

19. The method as in claim 18 wherein the female component inner layer comprises a metal and the outer layer comprises a plastic.

20. The method as in claim 18 wherein the female component inner layer comprises a metal and the outer layer comprises a rubber.

21. The method as in claim 18 further comprising attaching the male and female components to an equestrian piece of equipment.

22. The method as in claim 21 wherein the equestrian piece of equipment comprises a blanket.

23. The method as in claim 21 wherein the equestrian piece of equipment comprises a leg guard.
